(19) United States
(12) Patent Application Publication
(10) Pub. No.: US 2005/0035880 A1
(43) Pub. Date: Feb. 17, 2005

(54) Inductive loop detector

(76) Inventor: Roland, Victoria (AU)

Correspondence Address: KLAUBER & JACKSON, 411 HACKENSACK AVENUE, HACKENSACK, NJ, 07601, US

(21) Appl. No.: 10/490,912

(22) PCT Filed: Sep. 27, 2002
(86) PCT No.: PCT/AU02/01314

(30) Foreign Application Priority Data
Sep. 27, 2001 (AU) PR 7981
Oct. 31, 2001 (AU) PR 8605

(51) Int. Cl. G08G 1/01

(52) U.S. Cl. 340/941

(57) ABSTRACT

In a fast aspect, this invention provides a surface-mount inductive loop detector including: a pad having encased therein an inductive loop which is adapted for connection to an external electronic controller device; said pad being fixed within a hardened, bevelled peripheral edge that is provided with means for fixing the pad to a surface. In a second aspect, this invention provides a surface-mount inductive loop detector including: an inductive loop which is adapted for connection to an external electronic controller device; a protective cover in the form of a substantially inflexible ring having a hardened, bevelled peripheral edge; said ring adapted to accommodate the inductive loop between a mounting surface and a lower surface of the ring and provided with means for fixing the detector to the mounting surface.

### FIELD OF INVENTION

This invention is in the field of inductive loop detectors. In particular, the invention relates to inductive loop detectors integrated with a protective cover that allows for surface or in-ground mounting.

### BACKGROUND OF THE INVENTION

Inductive loop detectors are well sown in the art generally for the purpose of motor vehicle detection Usually the loop includes of one or more turns of a conductive wire embedded under or within the surface of a roadway, or the like, over which passes a vehicle that is to be detected. Typically, the loop is rectangular or square measuring approximately 1.5 to 2 metres across and includes wire tails, which lead to well known electronic devices that cause the loop to oscillate at a predetermined frequency. Changes in the frequency in the loop are monitored to detect the presence of a vehicle over or near the loop.

Inductive loop detectors are normally made by cutting a pattern slit into concrete slabs or bitumen approximately forty-millimetres deep and three-millimetres wide. A wire is then laid down into the pre-cut slit, being the pattern form, at least two to four times around the pattern in order to form an inductive loop coil. The wire is then scaled into the pr-cut slit with cement, outing compound or other adhesive sealants. The in-ground inductive loop is activated when a phase-locked frequency is passed through the wire loop form by means of an external electronic control device. The active loop acts as a metal detection device for detecting approaching motor vehicles. This type of inductive loop detector is designed primarily to pick up vehicle wheel rims, and has a relatively short range of field sensitivity, with respect to metal detection, particularly in respect of height from ground surface. In-ground inductive loop detectors are commonly used to activate electric doors, in particular rapid-opening curtains, doors or gates, and are also used on roadways to activate traffic control signal lights by detecting approaching motor vehicles.

Surface-mounted detectors have been described such as, for example, in U.S. Pat. No. 4,945,356 by Henderson et al. Such detectors are subject to potentially damaging stresses of the passage of heavy vehicles, abrasion, weathering and spilled corrosive substances. In addition, these detectors often are exposed to vandalism.

The present invention seeks, at least in par; to overcome these identified problems in the prior at

### SUMMARY OF THE INVENTION

In a first aspect this invention accordingly provides a surface-mount inductive loop detector including:
a pad having encased therein an inductive loop which is adapted for connection to an external electronic controller device;
said pad being fixed within a hardened, bevelled peripheral edge that is provided with means for fixing the pad to a surface.

For the protection of the inductive loop, it is an advantage if the pad is resilient or semi-rigid or the like.

The hardened, bevelled peripheral edge may be integral with the pad or a discrete structure within which the pad is fixed.

It is advantageous if the hardened, bevelled peripheral edge of the pad includes a metal ring to serve the purpose of providing protection and strength to the edge of the pad. Further, it is particularly preferred that the metal ring has at least one discontinuity in its structure.

In a second aspect, this invention accordingly provides a surface-mount inductive loop detector including:
an inductive loop which is adapted for connection to an external electronic controller device;
a protective cover in the form of a substantially inflexible ring having a hardened, bevelled peripheral edge;
said ring adapted to accommodate the inductive loop between a mounting surface and a lower surface of the ring and provided with means for fixing the detector to the mounting surface.

Preferably the ring includes, on its under surface, a charnel within which the inductive loop may be coiled. For some uses in which the detector may be buried, at least partially, within or below a surface (such as a bitumen or concrete surface), the channel may be enclosed with a second ring to protect the inductive loop.

The inner circumferential edge of the ring preferably is hardened and bevelled similar to the outer edge. However, if it is desired to provide an infill disc to close the inner area of the ing, the inner circumferential edge is provided with an engaging shoulder.

It is advantageous if the protective ring is constructed from a metallic material. Such a metal ring provides protection of the inductive loop and adds structural strength to the detector.

In both aspects of the invention it has been found that the incorporation of a metal ring in do detector may induce a reduction in field strength of the inductive loop of about 50% compared to an unprotected loop.

It has been found that this disadvantage can be overcome by the use of a discontinuous metal ring. It is preferred that the discontinuity in the ring is provided by making a radial cut of about 1 mm in width through the ring to provide a gap. Such a feature not only overcomes the reduction in field strength but also has the effect of strengthening the inductive field in both the horizontal and vertical dimensions by about 30%, thus enabling the use of a smaller detector to achieve a given coverage of area.

The discontinuous metal ring may be multi-segmented if required for a given purpose but there is no apparent advantage in increasing field strength if the cuts in the ring are varied from 1, 2, 3 or 4.

A stainless steel discontinuous ring provides good qualities of strength and enhancement of field strength. Similar qualities may be provided by aircraft-grade aluminium, aluminium alloy, mild or hardened steel or the like.

Generally it is most convenient if the detector is substantially circular in shape, although alternative such as an ellipse, an oval or the like may be suitable.

Whilst the wire tails of the inductive loop could be laid in a cut or indentation in the surface on which the detector is mounted, it is preferred that the detector includes a protective cover for the wire tails including a bevelled, hardened track attached to the protective ring and adapted for attachment to a surface.

### BRIEF DESCRIPTION OF THE VIEW OF THE DRAWINGS

FIG. 1 is a top view of a surface-mount inductive loop detector according to the first aspect of the invention

FIG. 2 is a bottom view of the detector of FIG. 1.

FIG. 3 is a top view of the metal ring of the detector of FIG. 1.

FIG. 4 is a bottom view of the metal ring of the detector of FIG. 1.

FIG. 5 is a cross sectional view of the detector of FIG. 1.

FIG. 6 is a top view of the plastic disc pad of the detector as shown in FIG. 1.

FIG. 7 is a cross sectional view of the plastic disc pad of FIG. 6.

FIG. 8 is a top view of the wire carrier track of the detector as shown in FIG. 1.

FIG. 9 is a cross section of the track of FIG. 8.

FIG. 10 is a cross sectional view of the wire carrier track and coupling joint of the detector as shown in FIG. 1.

FIG. 11 is a top view of a surface-mount inductive loop detector according to the second aspect of the invention.

FIG. 12 is a bottom view of the detector of FIG. 11.

FIG. 13 is a side cross-sectional view of the detector of FIG. 11.

FIG. 14 is a side cross-sectional view of an alternative embodiment of a detector according to the second aspect of the invention.

FIG. 15 is a magnified cross sectional view of the detector of FIG. 13.

FIG. 16 is a top view of the wire carrier tack of the detector as shown in FIG. 11.

FIG. 17 is a cross section of the tack of FIG. 16.

FIG. 18 is a cross sectional view of the wire carrier track and coupling joint of the detector as shown in FIG. 11.

FIG. 19 is an “exploded” view of FIG. 13 illustrating how a loop guide fits into a channel in the base of the protective cover.

FIG. 20 is aside cross sectional view of the loop guide of FIG. 19.

FIG. 21 is a top view of a loop guide and wire loop.

FIG. 22 is a magnified view of the wire tail exit from the loop guide shown within the dotted region of FIG. 21.

FIG. 23 is a plan view of a segmented second ring for protection of a loop guide and wire loop in uses in which the detector of FIG. 11 or 14 is to be buried within or below a surface.

FIG. 24 is a side cross-sectional view of a detector of FIG. 13 or 14 adapted to receive the second ring of FIG. 23.

### DETAILED DESCRIPTION WITH RESPECT TO THE DRAWINGS

First Aspect of the Invention

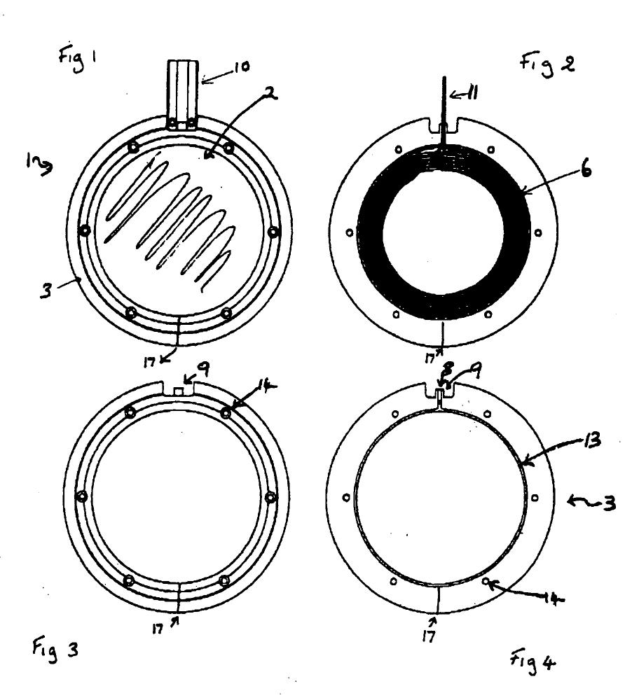

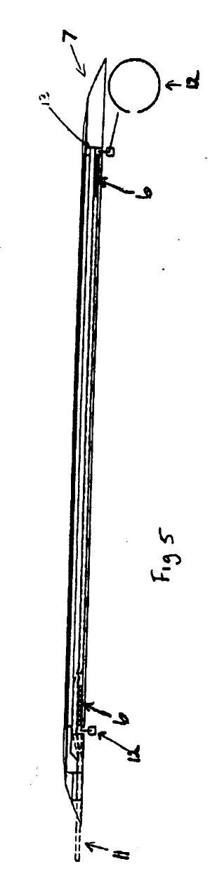

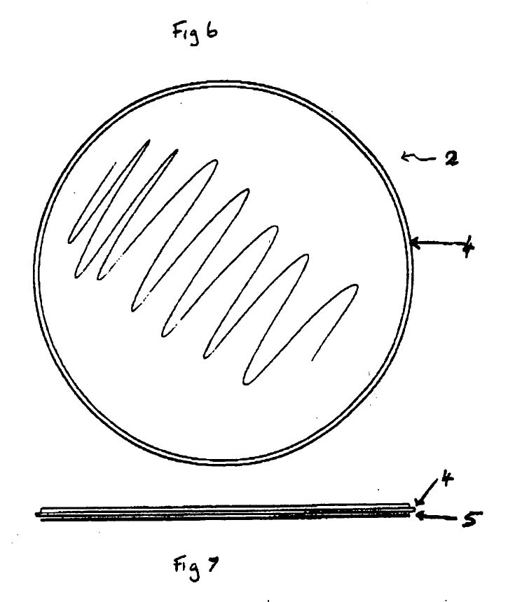

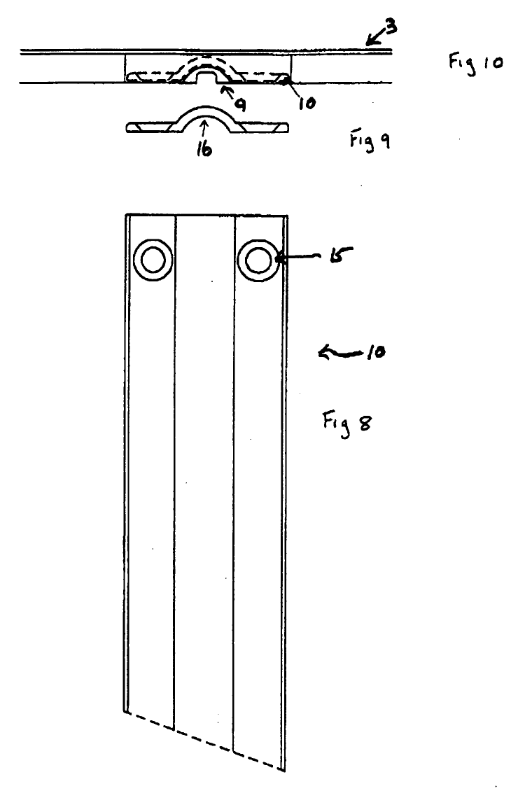

A surface mount inductive loop detector (1) according to the invention, shown in FIGS. 1 and 2, includes a substantially flat disc, which includes of two main parts. A resilient, cut-resistant, hard plastic type disc pad (2), sown in FIGS. 6 and 7, (which will henceforth be referred to as a ‘plastic disc’) is fixed within a hardened metal outer ring (3), shown in FIGS. 3 and 4. The metal ring has a discontinuity in the form of a single radial gap (17) of about 1 mm in width

The plastic disc (2), shown in FIG. 7, has a lip (4) around its entire circumference that engages with a shoulder within the inner circumference of the metal ring. The plastic disc also has a circumferential channel (5) to house and protect the coiled inductive wire loop form (6) as illustrated in FIGS. 2, 5 and 7. Teflon coated wire of 1.5 mm-2 mm diameter is preferred for the inductive wire because of its protective coating strength. The wire is coiled multiple times around the circumference of the plastic disc within the channel. Inductive loop pads with a radius of approximately 150 mm, or less, require a minimum of six coils of wire for the filter loop to Zion effectively. Five or less coils induce a filter loop fail of the electronic controller device.

The plastic disc can be mould or injection-mould formed or machined from various plastic type materials, such as polypropylene, hard nylon, rubber, polycarbonate, fibreglass, epoxy resins or other similar type composites. If desired, the surface of the plastic disc can be textured or formed with raised projections (not illustrated) to give the disc a tractive surface and to act to absorb abrasive damage. Suitable raised projections, for example, could be hemi spherical in shape with general dimensions of a height of about 0.5 mm and diameter of about 30 mm.

The outer metal ring acts to shield the plastic disc, in particular the outer edge of the disc, which houses the coiled wire loop form, shown in FIGS. 2 and 5, from external damage. The metal ring (3) has a bevelled edge (7) to resist pick-up and deflect impact. FIG. 4 shows the bottom view of the metal ring, showing a channel (8) nag through a coupling-joint (9) for routing the loop form wires through to a wire carrier track (10). FIG. 2 shows the bottom view of the detector, illustrating the coiled wire loop form (6) and the wire tails (11) of the loop leading out through the metal ring and away from the detector. A square-section stainless steel ring (12), as shown in FIG. 5, is used to bridge the filter loop field between the inductive loop wire form housed in the plastic disc and the outer metal ring in order to maintain optimum field integrity and ensure no loss of field detecting range during normal operation of the device. The square-section ing (12) also serves to fix the plastic disc within the metal ring by urging the plastic disc against a shoulder (13) within the inner circumferential edge of the metal ring (3).

Apart from the benefit of protecting the plastic disc, the metal ring acts to increase the range of field sensitivity of the inductive loop by up to three-fold, which allows for an effective functional device to have a minimum external ring radius of approximately 100 mm.

Stainless steel is the preferred material for the construction of the metal ring due to its overall strength and hardenable properties and all-round resistance to weathering and chemical corrosion. Similar properties can be obtained from aircraft-se aluminium, aluminium alloy, mild or hardened steel or the like. The metal ring can be forged, roiled, cast, die-cast and/or machined from plate metal.

The surface mount pad may be bolted and/or bonded to a desired surface deponing on required application. As an aid for mounting, the metal ring is provided with a plurality of holes (14) adapted to accept bolts or similar fasteners.

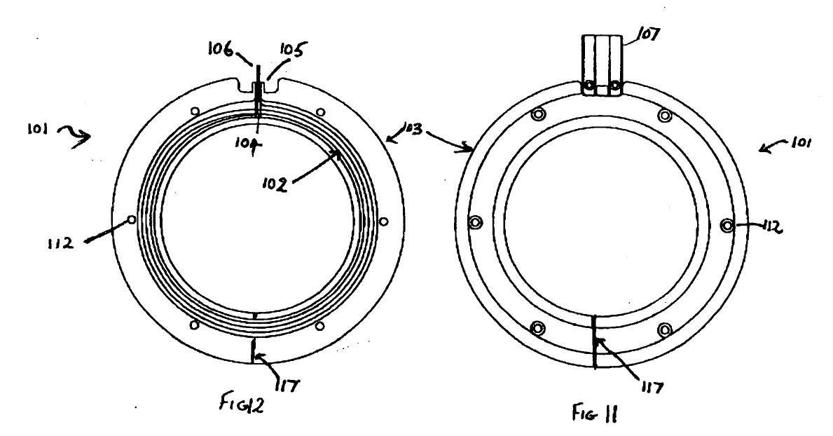

The surface-mount inductive loop pad has wire tails (11) for connecting to an external electronic controller device, normally located two to ten metres away from the pad. In most cases, the wiring would have to be laid down into a pre-cut slit in concrete or bitumen and sealed over with a suitable sealing compound. To negate this method of cutting the surface and sealing the connecting wires into the surface, the connecting wires are routed to the controller above ground and protected within a metal carrier track (10), shown in FIGS. 8 and 9, which can be bolted and/or bonded down to the chosen surface. Suitable holes (15) are provided to accept bolts or similar fasteners if required.

The metal wire carrier track has a spherical-section inner profile (16), shown in FIG. 9, which houses the connecting wires and couples to the corresponding spherical-section coupling-joint (9), shown in FIG. 10, the spherical joint being a part of the metal ring shown in FIGS. 3 and 4. The spherical-section wire carrier track and corresponding joint allow for angular adjustment of the carrier track, relative to installation position required for the respective installation. The wire carrier track preferably is constructed of stainless steel and has a radiused or bevelled side-edge to resist pick-up, and deflect associated forms of damage of possible damage associated within the particular working environment.

Second Aspect of the Invention

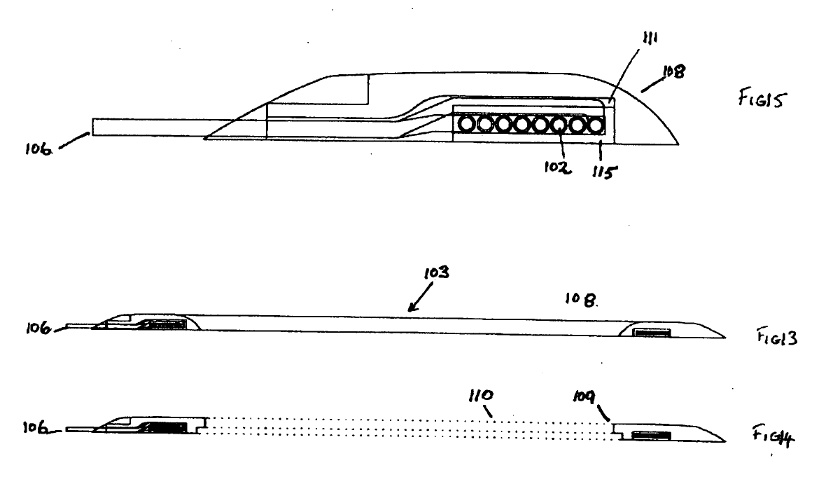

A surface mount inductive loop detector (01) according to the invention, shown in FIGS. 11 and 12, includes a wire inductive loop (102) protected by a protective cover in the form of a substantially flat metal ring (103). The metal ring has a discontinuity in the form of a single radial gap (117) of about 1 mm in width.

The metal ring has a bevelled outer edge to resist pick-up and deflect impact. The top surface of the metal ring may be knurled, stippled, textured or indented to provide a tractable surface. FIG. 12 shows the bottom view of the metal ring, illustrating a charnel (104) running through a coupling joint (105) for routing the tails (106) of the loop form wires through the protective ring to a wire carrier track (107).

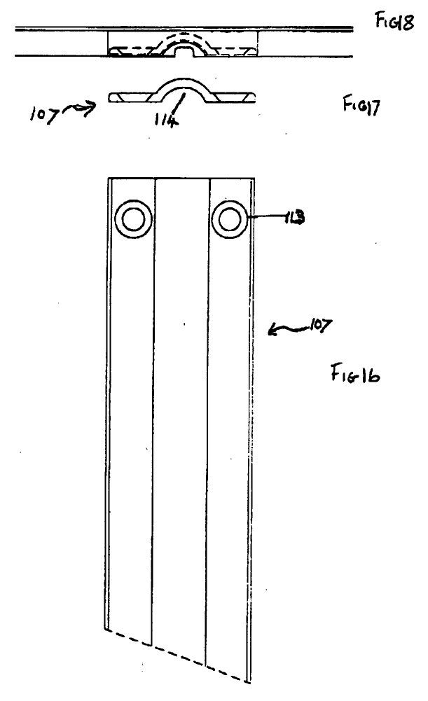

The metal ring is provided with one of two inner edge profiles. The inner edge profile (108) shown in FIG. 13 has a bevelled configuration and this particular profile allows for the metal rg to be used without an inner disc or pad. The second inner edge profile (109), as shown in FIG. 14, provides for holding an infill disc of plastic, rubber or other type of synthetic or organic composite type material or the like. The disc (110) is shown in a dotted, ghost form in FIG. 14. The top surface of the inner disc may be stippled, textured or indented to provide a tractable and/or aesthetic surface.

The under surface of the ring includes a rectangular-section channel (111), as shown in FIGS. 15 and 19. The channel accommodates a ring-form loop guide (115), shown in FIGS. 20 and 21, having a groove (116) win its circumferential edge. The groove is used to wind the wire loop form within to provide form and support to the inductive loop (102). Preferably the loop guide is formed in a plastic ring. For use in forming the inductive loop, 1.5 mm-2 mm Teflon coated wire is preferred because of its protective coating strength. The wire is coiled multiple times around the circumference of the loop guide within the groove. FIG. 22 illustrates the windings of the wire and shows the wire tails (106) of the inductive loop (102) leaving the loop guide. Inductive loop rings with an outer ring radius of approximately 150 mm require a number of six coils of wire for the filter loop to function Usually five coils or less induces a filter loop fail of the electronic controller device.

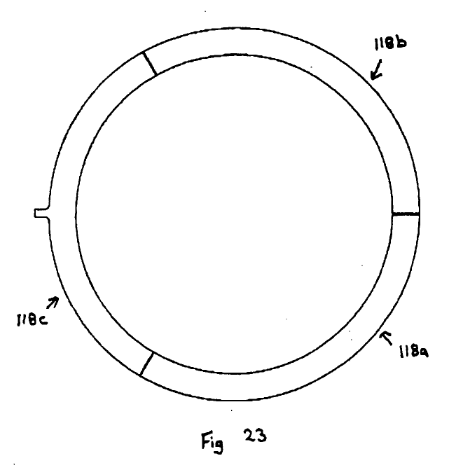

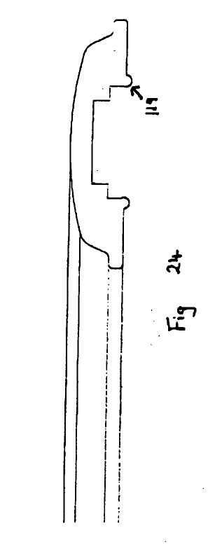

In cases in which the detector is to be buried, at least partially, within or below a surface, the channel (111) is enclosed by a second ring (118) to protect the inductive loop (102). As shown in FIG. 23, the second ring (118) is made up of three discrete segments (118a, 118b, 118c) for ease of placement into and removal from the detector. The second ring (118) is retained in place by pressure engagement with two shoulders (119) on the lower periphery of the channel (111).

Apart from the benefit of protecting the inductive loop, the discontinuous metal ring acts to increase the range of field sensitivity of the inductive loop by up to 30% (compared to an unshielded loop), which allows for an effective functional device to have a minimum external ring radius of approximately 100 mm.

Stainless steel is the preferred material for the construction of the metal ring due to its overall strength and hardenable properties and all-round resistance to weathering and chemical corrosion. Similar properties can be obtained from aircraft-grade aluminium, aluminium alloy, mild or hardened steel or the like. The metal ring can be forged, rolled, cast die-cast and/or machined from plate metal.

The surface mount detector may be bolted and/or bonded to a desired surface depending on required application. As an aid for mounting, the metal ring is provided with a plurality of holes (112) adapted to accept bolts or similar fasteners.

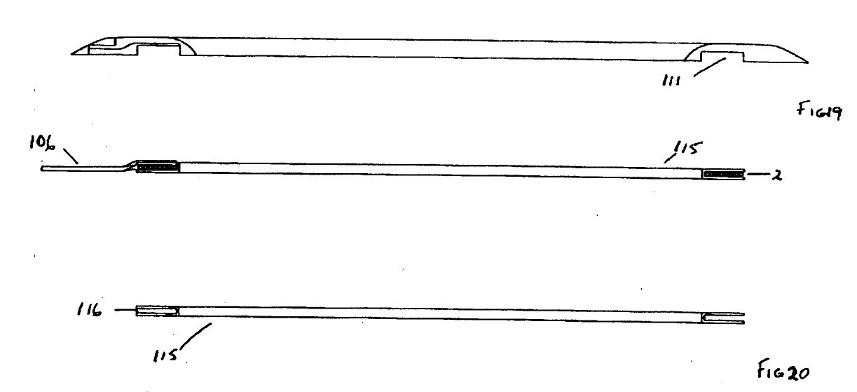

The surface-mount inductive loop has wire tails (106) for connecting to an external electronic controller device, normally located two to ten metros away from the detector. In most cases, the wiring would have to be laid down into a pre-cut slit in concrete or bitumen and sealed over with a suitable sealing compound. To negate this method of cutting the surface and sealing the connecting wires into the surface, the connecting wires are routed to the controller above ground and protected within a metal carrier track (107), shown in FIGS. 16 and 17, which can be bolted and/or bonded down to the chosen surface. Suitable holes (113) are provided to accept bolts or similar fasteners if required.

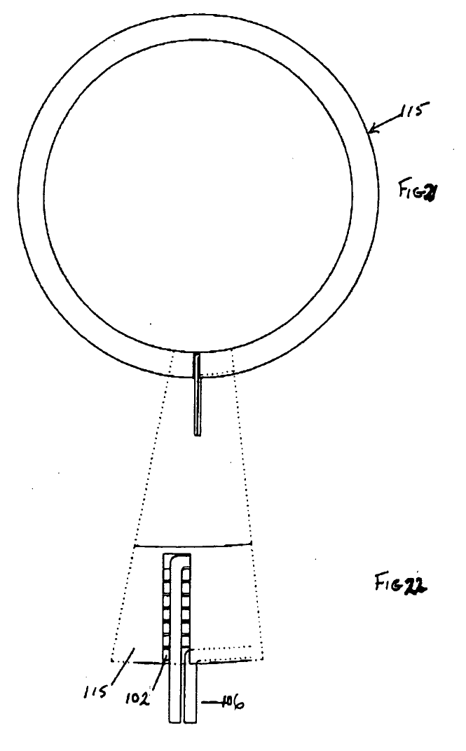

The metal wire carrier track has a spherical-section inner profile (114), shown in FIG. 17, which houses the connecting wires and couples to the corresponding spherical-section coupling-joint (105), shown in FIG. 18, the spherical joint being a part of the metal ring shown in FIGS. 11 and 12. The spherical-section wire carrier track and corresponding joint allow for angular adjustment of the carrier track, relative to installation position required for the respective installation. The wire carrier track preferably is constructed of stainless steel and has a radiused or bevelled side-edge to resist pick-up, and deflect associated forms of damage or possible damage associated within the particular working environment. The upper surface of the track may be textured, if desired, to provide a tractable surface.

Advantages of the Invention:

The surface-mount inductive loop detector of the invention performs the same function as an in-ground inductive loop detector device, without the normal disadvantages associated with typical in-ground devices. Primarily the surface-mount inductive loop detector eliminates the need for machine cutting a slit Pattern into concrete or bitumen, and given that the diamond-blade cutting saw requires water for the procedure, the resultant mess of dust slurry and water is an arduous clean up task, which requires the use of a wet-dry vacuum. Generally the entire procedure of cutting and sealing is a nuisance and hindrance to other on-site workers. Furthermore, cutting a slit into concrete is a particular concern with load bearing slabs and ornate concreted or similar types of surface. Another commonly associated problem with in-ground installation of inductive loop detectors is wear and tear, inasmuch as when the loop wire is laid into bitumen roadways, the movement expansion, and compression of the bitumen has a tendency to sever the loop wire, which requires that the loop be recut and sealed. This is a particular nuisance, and a safety hazard where heavy traffic roadways are concerned, as these same roadways are also the most commonly affected by wear and tear and periodic reconstructions, in particular where additional traffic control signal lights and/or controls are required.

Present electronic loop detector control devices place a limit on the minimum dimension of the wire loop form in order for the filter loop to function; the minimum dimension being approximately a radius of 75 mm on the inner perimeter of the wire loop form. The use of a discontinuous metal ring, when placed adjacent to or over the outer perimeter of a coiled wire loop form, shown in FIG. 2 or 12, extends the range of field sensitivity for metal detection. A wire loop for with a given size of radius of 115 mm at the outer perimeter, has a range of field of that extends approximately 60 mm outwards from the wire loop form and approximately 100 mm upwards from the ground surface. The addition of a metal ring above the same 115 mm radius wire loop form extends the range of field to approximately 180 mm out from the wire loop form and approximately 300 mm up from the ground surface. Hence, a surface-mount inductive loop detector, as shown in FIG. 1 or 11, with a given outer-perimeter loop radius of 150 mm, has a range of field of approximately 300 mm radius and can easily detect a vehicle body shell, wheels or other metal components of a vehicle. The discontinuous metal ring acts to amplify the active range of field sensitivity for metal detection by the inductive coil by a factor of approximately three-fold. However, the degree of field sensitivity amplification is directly proportional to the overall size of the detector's inductive wire loop form. Increasing the radius of the wire loop form proportionally lower the degree of field sensitivity amplification achieved by the use of a metal ring. In addition, it is believed that once the size of the metal ring is increased beyond about 200 mm in radius, there appears to be no further gain in field sensitivity in the vertical dimension whilst the sensitivity in the horizontal dimension may continue to increase.

The detector can vary in size depending on a respective intended applications and can range in shape from being circular, elliptical, rectangular, square, or other shape, depending on the relevant intended application, as the relative shape does not impede the performance of the device. The shape of the device is proportionally relative to the desired surface area coverage with respect to the required range of field sensitivity for metal detection of each respective shape of the device.

In general in-ground inductive loop detectors actively cover 50%-100% of the respective surface area that is required to be covered by the inductive loop sensor, as these types of loop detection devices are normally expected to be triggered by the wheel rims of a moving vehicle. However, this amount of area coverage impedes fork-lifts to work storage areas adjacent to door openings, in particular when loading and unloading in these areas where the relating door is not required to trip open constantly. Unlike conventional in-ground loop detector devices, a circular detector according to the invention having an external ring radius of approximately 150 mm provides an active range of field sensitivity, with respect to metal detection sensitivity, over a ground surface coverage of a radius of approximately 300 mm, with a ground height range of sensitivity of approximately 300 mm. Such a detector is easily avoidable by fork-lifts loading and unloading in the same area, and hence the detector does not constantly trip the door open when not required.

The surface-mount inductive loop detector, when used in conjunction with the surface-mount wire carrier track, negates any need for slitting of concrete or bitumen, or other type surface, for installation. The cutting-free surface-mount method reduces installation time by some eighty-percent, which is a priority when inductive type loop detectors are cut into bitumen on public roads. In addition, the method does not affect the load-bearing specification of specific concrete slabs.

It will be appreciated that, whilst the foregoing has been given by way of illustrative example of the invention, all such modifications and variations thereto as would be apparent to persons skilled in the art are deemed to fall within the broad scope and ambit of the invention as described herein.

1. A surface-mount inductive loop detector including:
a pad having encased therein an inductive loop which is adapted for connection to an external electronic controller device;
said pad being fixed within a hardened, bevelled peripheral edge that is provided with means for fixing the pad to a surface.

2. A surface-mount inductive loop detector according to claim 1 further including a discontinuous metal ring surrounding the pad and in close proximity to the inductive loop.

3. A surface-mount inductive loop detector according to claim 2 wherein the discontinuous metal ring includes a face separated by an internal and external circumference, the internal circumference having a shoulder adjacent thereto which engages a portion of the pad to maintain the inductive loop(s) at an effective distance from and substantially adjacent to the metal ring.

4. A surface-mount inductive loop detector according to claim 2 further including a square-section metal ring forming a bridge between the inductive loop wire and the internal circumference of the discontinuous metal ring to assist maintaining the field integrity during normal operation of the detector.

5. A surface-mount inductive loop detector according to claim 2 in which the pad is a central disc having a peripheral lip extending around its circumference, the disc further including a channel adjacent the lip in which the inductive loop of wire is housed.

6. A surface-mount inductive loop detector according to claim 3 wherein the internal circumference of the discontinuous metal ring has a shoulder adjacent thereto which engages the lip portion of the central disc member to maintain the loops housed within the channel at an effective distance from and substantially adjacent to the metal ring.

7. A detector according to claim 1 in which the hardened, bevelled peripheral edge is a discrete structure within which the pad is fixed.

8. A detector according to claim 7 in which the peripheral edge of the pad includes a metal ring to serve the purpose of providing protection and strength to the edge of the pad.

9. A detector according to claim 8 in which the metal ring has a discontinuity in its structure.

10. A detector according to claim 9 in which the pad is resilient or semi-rigid.

11. A surface-mount inductive loop detector including:
an inductive loop which is adapted for connection to an external electronic controller device;
a protective cover in the form of a substantially inflexible ring having a hardened, bevelled peripheral edge;
said ring adapted to accommodate the inductive loop between a mounting surface and a lower surface of the ring and provided with means for fixing the detector to the mounting surface.

12. A detector according to claim 11 in which the ring includes, on its under surface, a channel within which the inductive loop is coiled.

13. A detector according to claim 12 in which the channel is enclosed with a second ring to protect the inductive loop.

14. A detector according to claim 12 in which the inner circumferential edge of the ring is hardened and bevelled similar to the outer edge.

15. A detector according to claim 12 which includes an infill disc to close the inner area of the ring and the inner circumferential edge is provided with a shoulder which engages the disc.

16. A detector according to claim 14 in which the protective ring is a metal ring.

17. A detector according to claim 16 in which the metal ring has a discontinuity in its structure.

18. A detector according to claim 17 in which the discontinuity is a radial through-cut.

19. A detector according to claim 16 in which the metal ring is multi-segmented.

20. A detector according to claim 1 including a protective cover for the tails of the inductive loop including a bevelled, hardened track attached to the protective ring and adapted for attachment to a surface.

21. An above-ground inductive loop detector including:
a central disc member having a peripheral lip extending around its entire circumference, the disc member further including a channel adjacent the lip in which at least one loop of inductive wire is received, the at least one loop being adapted for connection to an external electronic controller device so that an induced electromagnetic field can be generated;
a discontinuous metal ring surrounding the central disc member, the metal ring including a face separated by an internal and external circumference wherein the internal circumference has a shoulder adjacent thereto which engages the lip portion of the central disc member to maintain the loops housed within the channel at an effective distance from and substantially adjacent to the metal ring;
wherein when the at least one wire loop is connected to the electronic control device, the discontinuous metal ring enhances the induced electromagnetic field sensitivity generated by the wire loops.

22. The above ground inductive loop detector according to claim 21 further including a square-section metal ring forming a bridge between the at least one inductive loop wire housed within the channel and the internal circumference of the metal ring to assist maintaining the field integrity during normal operation of the detector and to urge the central disc member against the shoulder within the internal circumferential edge of the metal ring.

23. The above ground inductive loop detector according to claim 21 wherein the internal circumference and external circumference of the metal ring are disposed at an angle so that the face of the ring forms a bevelled edge over which vehicular traffic can travel.
